(19) United States
(12) Patent Application Publication
(10) Pub. No.: US 2020/0083648 A1
(43) Pub. Date: Mar. 12, 2020

(54) HIGH SPEED ELECTRICAL CONNECTOR

(71) Applicant: Amphenol FCI Connectors Singapore Pte. Ltd., Singapore (SG)

(72) Inventors: Abin Simon Kurudamannil, Cochin (IN); Biju K. Paul, Cochin (IN); Alex Babu Thuruthummalil, Cochin (IN); Binesh C. Devimandiram, Cochin (IN)

(73) Assignee: Amphenol FCI Connectors Singapore Pte. Ltd., Singapore (SG)

(21) Appl. No.: 16/305,538

(22) PCT Filed: May 31, 2017
(86) PCT No.: PCT/SG2017/050277

§ 371 Date: Nov. 29, 2018

(30) Foreign Application Priority Data
Jun. 1, 2016 (IN) 201641018893

(51) Int. Cl. H01R 13/6581; H01R 12/72; H01R 43/20; H01R 12/71; H01R 13/514; H01R 13/6471

(52) U.S. Cl. CPC H01R 13/6581; H01R 12/724; H01R 13/6471; H01R 12/716; H01R 13/514; H01R 43/20

(57) ABSTRACT

An electrical connector comprises a housing having a mating direction, a width direction orthogonal to the mating direction and a height direction orthogonal to the mating direction and the width direction. Low speed signal contacts and high speed signal contacts are arranged in the housing. Ground bars are each disposed between adjacent two of the contacts. A support member is attached to the housing and engaged to the ground bars. The support member has a main body disposed along the width direction and fingers extending laterally from the main body. Each of the fingers being in alignment with one of the low speed signal contacts along the mounting direction. The fingers are positioned away from the high speed contacts to achieve better signal integrity and crosstalk reduction.

### FIELD OF THE INVENTION

The present invention relates to an electrical connector and in particular to a high speed electrical connector.

### BRIEF DESCRIPTION OF THE DRAWINGS

FIG. 1 is a perspective view of a high speed electrical connector according to one embodiment of the present invention;

FIG. 2 is a perspective of the a high speed electrical connector shown in FIG. 1 when mounted to a printed circuit board;

FIG. 3 is an exploded perspective view of FIG. 1;

FIG. 4 is a partial enlarged view of portion P1 of FIG. 1;

FIG. 5 is a perspective view of a high speed electrical connector shown in FIG. 1 where the housing is omitted;

FIG. 6 is a top view of portion P5 of FIG. 5;

FIG. 7 is a perspective view of the contact aligner of the electrical connector shown in FIG. 1;

FIG. 8 is a perspective bottom view of contact assemblies of the electrical connector shown in FIG. 1;

FIG. 9A is a perspective bottom view of a contact assembly of the electrical connector shown in FIG. 1 and the contact aligner of FIG. 7 attached to the contact assemblies;

FIG. 9B is an enlarged partial view of FIG. 9A;

FIG. 10 is a perspective view of a high speed electrical connector according another embodiment of the present invention;

FIG. 11 is a perspective view of a high speed electrical connector shown in FIG. 10 where the housing is omitted;

FIG. 12 is an exploded perspective view of FIG. 10;

FIG. 13 is a partial enlarged view of portion P10 of FIG. 10;

FIG. 14 is a top view of portion P11 of FIG. 11.

### DETAILED DESCRIPTION

According to an aspect of the disclosure, an electrical connector is provided. The electrical connector comprises a housing having a width direction and a mounting direction orthogonal to the width direction, a plurality of low speed signal contacts arranged in the housing along the width direction, a plurality of high speed signal contacts arranged in the housing along the width direction, a plurality of ground bars, each ground bar being disposed between adjacent two of the low signal contacts; a member having a body disposed along the width direction, wherein fingers extend laterally from the body. Each of the fingers are in alignment with one of the low speed signal contacts along the mounting direction. Two or more high speed signal contacts being are disposed between adjacent fingers.

In some embodiments, the body is associated with a support member attached to the housing.

In some embodiments, the body is associated with a shield attached to the housing.

In some embodiments, the housing comprises ridges formed on a top surface thereof, and the fingers are inserted between adjacent ridges.

In some embodiments, the low speed signal contacts are positioned spaced apart by a first contact pitch and the high speed signal contacts are positioned spaced apart by a second contact pitch. In some embodiments, the second contact pitch is substantially the same as the first contact pitch.

In some embodiments, the fingers in a first segment of the body are separated by a first finger pitch and the fingers in a second segment of the body are separated by a second finger pitch. In some embodiments, the first finger pitch is the same as the first contact pitch. In some embodiments, the second finger pitch is greater than the second contact pitch.

In some embodiments, each of the fingers is in alignment with one of the low speed signal contacts in the first segment.

In some embodiments, two or more high speed contacts are disposed between adjacent fingers in the second segment.

In some embodiments, two or more high speed signal contacts are exposed between the adjacent fingers in the second segment.

According to another aspect of the disclosure, a method of constructing an electrical connector is provided. The method comprises attaching a body to a housing of the electrical connector having a width direction and a mounting direction orthogonal to the width direction, wherein a plurality of low speed signal contacts and a plurality of high speed signal contacts are arranged in the housing along the width direction, and the body is disposed along the width direction, and wherein fingers extend laterally from the body, and aligning each of the fingers with one of the low speed signal contacts, wherein two or more high speed signal contacts are disposed between adjacent fingers.

In some embodiments, the method further comprises inserting the fingers between ridges formed on a top surface of the housing.

In some embodiments, attaching the body to the housing of the electrical connector comprises attaching a support member having the body to the housing.

In some embodiments, attaching the body to the housing of the electrical connector comprises attaching a shield having the body to the housing.

In some embodiments, the method further comprises exposing the two or more high speed signal contacts between the adjacent fingers.

According to another aspect of the disclosure, a method of operating an electrical connector is provided, where the electrical connector comprises a conductive body attached to a housing of the electrical connector having a width direction and a mounting direction orthogonal to the width direction, and the conductive body is disposed along the width direction, and wherein fingers extend laterally from the conductive body such that the fingers are aligned with first type signal contacts and two or more second type signal contacts are disposed between adjacent fingers. The method comprises coupling low speed signals through the first type signal contacts and coupling high speed signals through the second type signal contacts.

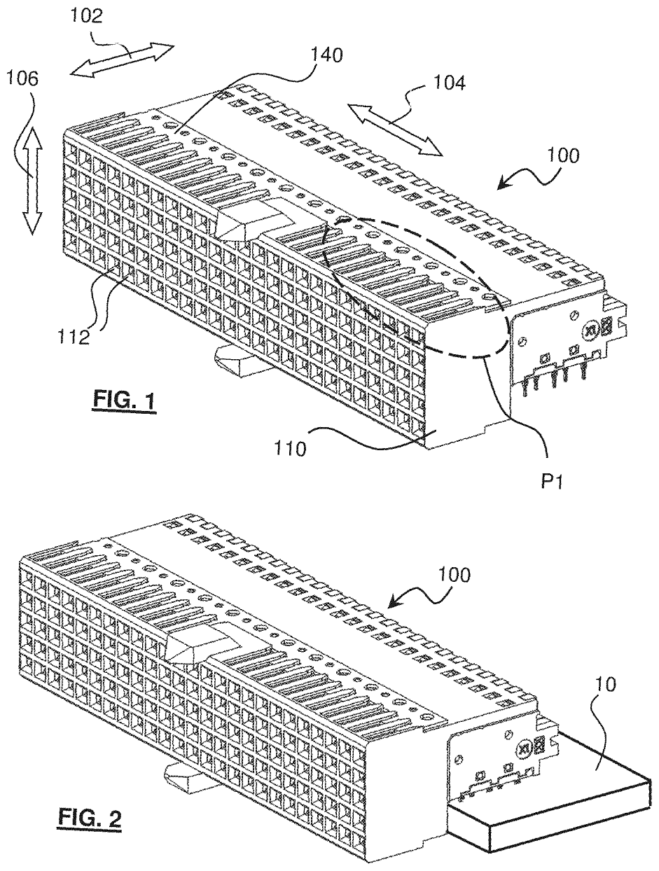

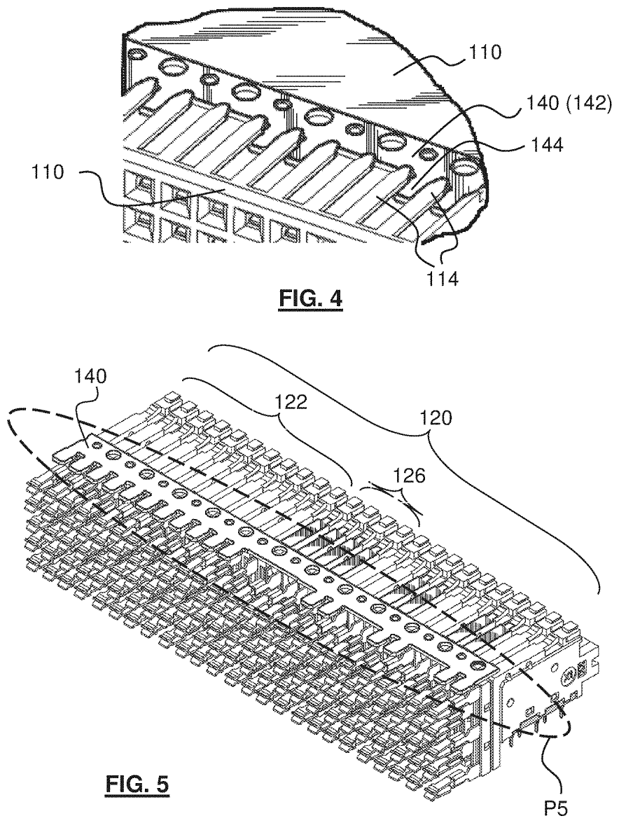

As shown in FIGS. 1 to 6, according to one embodiment, a high speed electrical connector 100 has a housing 110 and contacts 120 disposed in housing 110. Housing 110 has a mating direction 102 along which electrical connector 100 is mateable to a counterpart connector (not shown in the drawings), a width direction 104 orthogonal to mating direction 102, and a height direction 106 orthogonal to mating direction 102 and width direction 104. Formed in housing 110 there is an array of compartments 112, arranged along width direction 104 and height direction 106, respectively. In each compartment 112, there is disposed one of the contacts 120.

Contacts 120 include low speed signal contacts 122 and high speed signal contacts 126. Electrical connector 100 includes one or more ground bars 130 and a support member 140. Each ground bar 130 is disposed between adjacent contacts 120. Housing 110 has ridges 114 formed on top surface thereof. Support member 140 has a main body 142 and fingers 144 extending laterally from main body 142. Support member 140 is attached to housing 110 with main body 142 arranged parallel to width direction 104, and with each finger 144 inserted between adjacent ridges 114 of housing 110. Each finger 144 is in alignment with one of the low speed signal contacts 122 located underneath one of the fingers 144, along height direction 106.

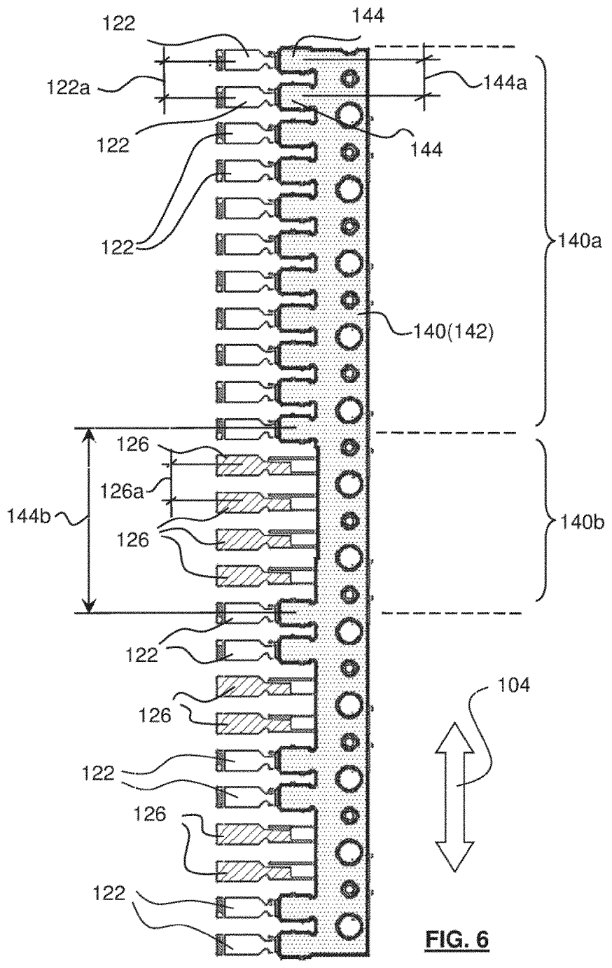

As shown in FIG. 6, low speed signal contacts 122 are positioned spaced apart from each other by first contact pitch 122a. Likewise, high speed signal contacts 126 are positioned spaced apart from each other by second contact pitch 126a which is substantially the same as first contact pitch 122a.

Support member 140 includes first segment 140a and second segment 140b, along width direction 104. Fingers 144 of support element 140 in first segment 140a are separated from each other, by first finger pitch 144a. Fingers 144 of support element 140 on second segment 140b are separated from each other, by second finger pitch 144b. First finger pitch 144a is the same as first contact pitch 122a. Second finger pitch 144b is greater than second contact pitch 126a, e.g. as that shown in FIG. 6, second finger pitch 144b is five times as second contact pitch 126a, i.e. there are disposed four high speed contacts 126 between adjacent fingers 144 in the second segment 140b. With first and second finger pitch 144a, 144b configured in the above-illustrated manner, each finger 144 is in alignment with one of the low speed contacts 122, and two or more high speed contacts 126 are disposed between two adjacent fingers 144. As such, high speed contacts 126 are exposed between adjacent fingers 144 of support element 140. Fingers 144 are positioned away from high speed contacts 126 to achieve better signal integrity through reduction in insertion loss and improvement in resonance performance.

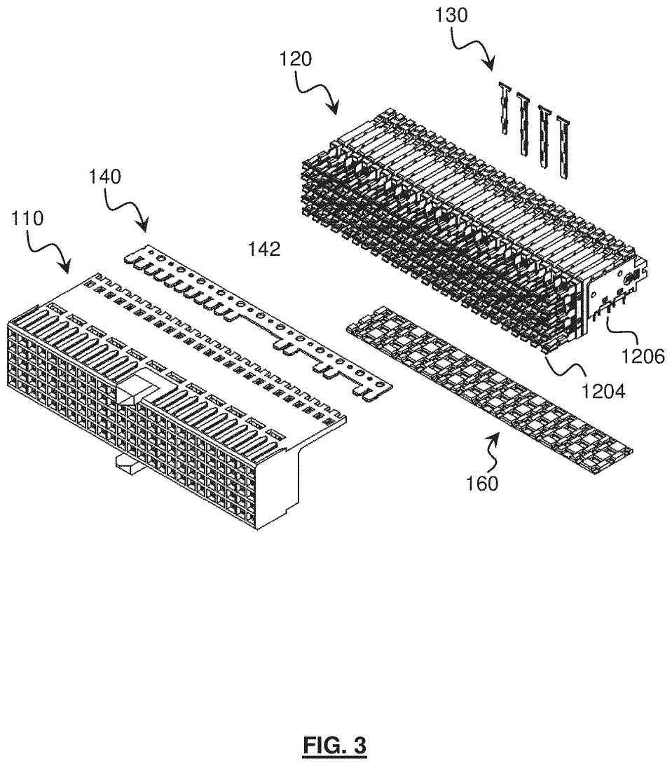

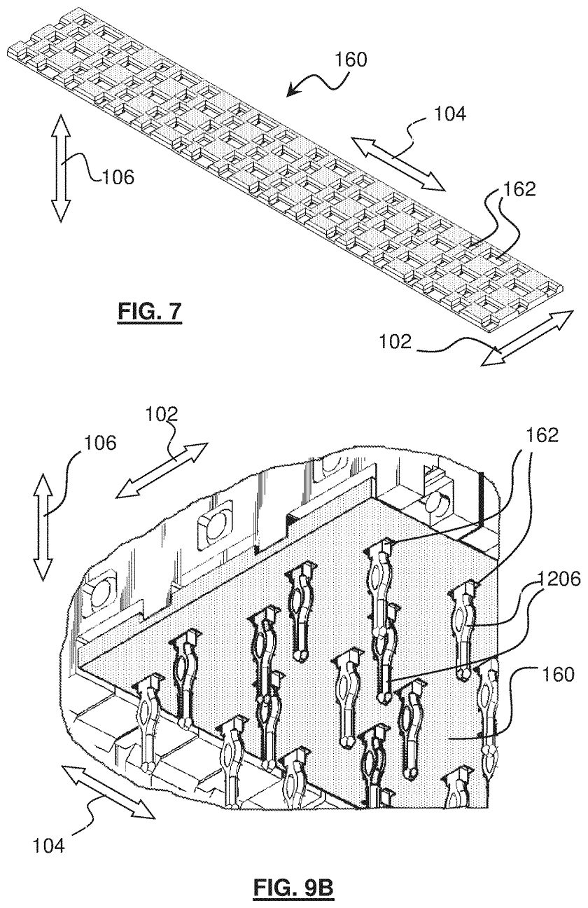

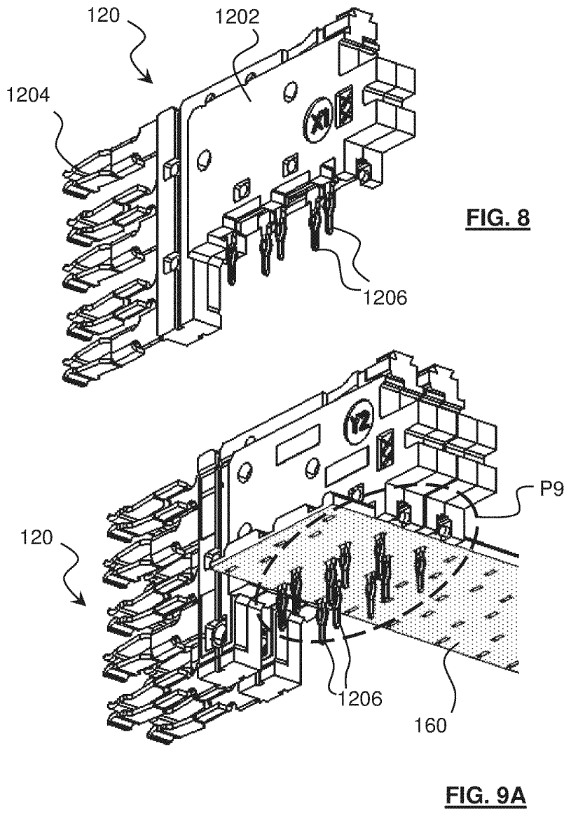

Electrical connector 100 may include a contact aligner 160 attached to bottom side of housing 110. With reference to FIGS. 3, 7, 8, 9A and 9B, contact aligner 160 is generally plate-shaped having apertures 162 formed thereon. Contacts 120 may be included in a type of Insert-Molded Leadframe Assembly (IMLA) having mating portions 1204 disposed in compartment 112, and tail portions 1206 extending outwardly from housing 110, for mounting to PCB 10. Each tail portion 1206 is press-fitted and passes through a corresponding aperture 162 of contact aligner 160. Retained by contact aligner 160, tail portions 1206 are better aligned in position, and become stronger to resist deflection with respect to mating direction 102 and width direction 104. Structural integrity and robustness of electrical connector 100 is improved.

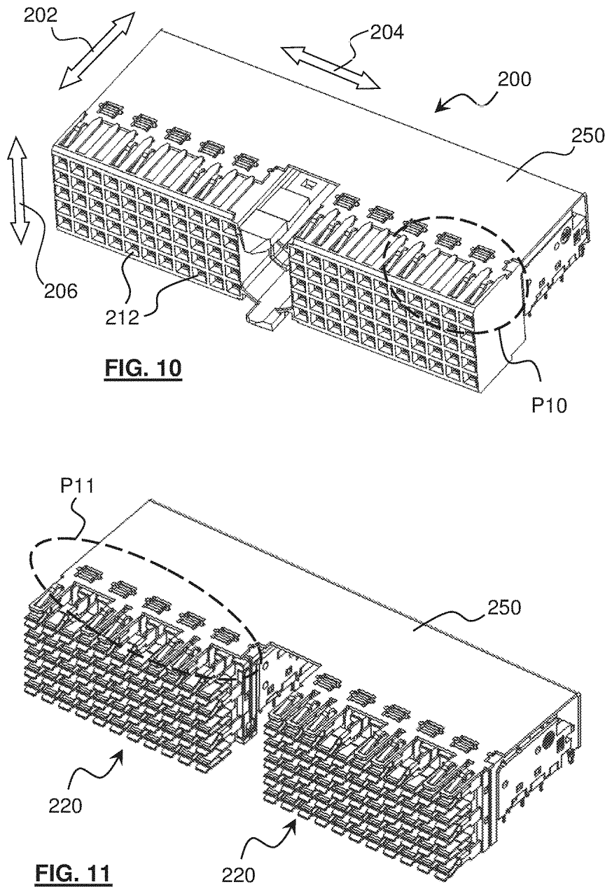

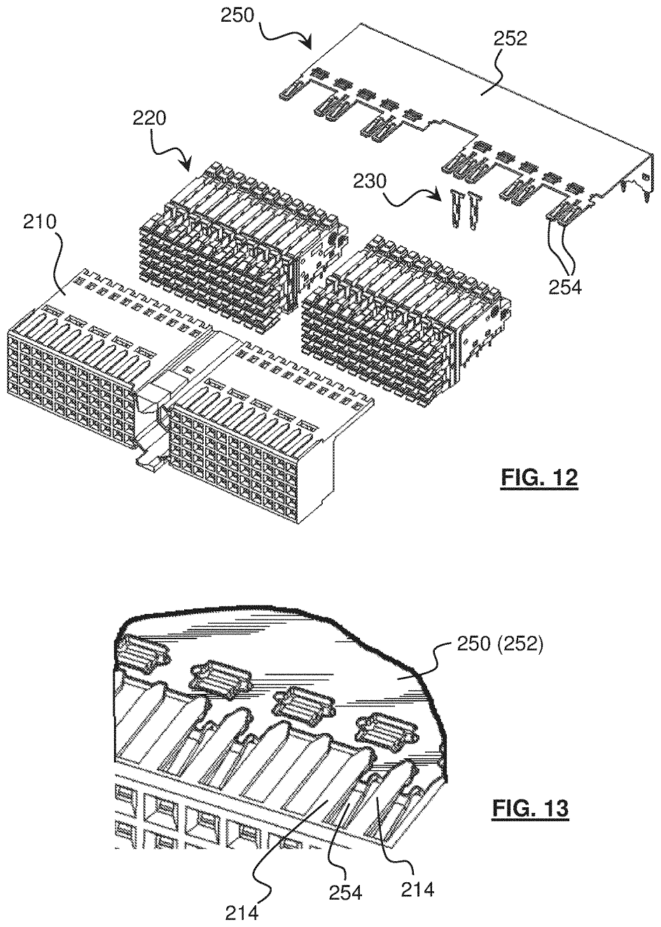

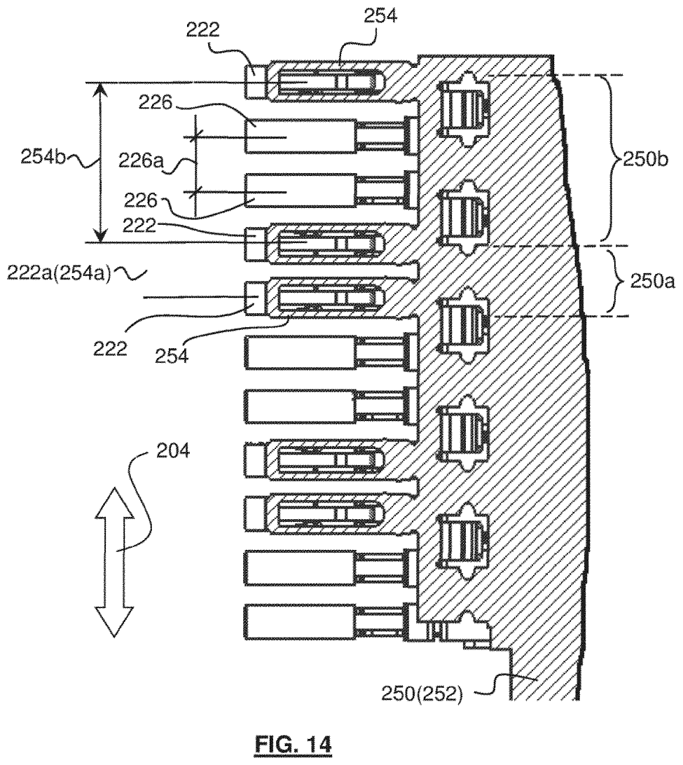

According to another embodiment, as shown in FIGS. 10 to 14, a high speed electrical connector 200 has a housing 210 and contacts 220 disposed in housing 210. Electrical connector 200 includes one or more ground bars 230. Each ground bar 230 is disposed between adjacent contacts 220. Housing 210 has a mating direction 202 along which electrical connector 200 is mateable to a counterpart connector (not shown in the drawings), a width direction 204 orthogonal to mating direction 202, and a height direction 206 orthogonal to mating direction 202 and width direction 204. Formed in housing 200 there is an array of compartments 212, arranged along width direction 204 and height direction 206, respectively. In each compartment 212, there is disposed one of the contacts 220.

Contacts 220 includes low speed signal contacts 222 and high speed signal contacts 226. Electrical connector 200 include a shield 250 attached to housing 210. Housing 210 has ridges 214 formed on top surface thereof. Shield 250 has a main body 252 and fingers 254 extending laterally from main body 252. Shield 250 is attached to housing 210 with main body 252 arranged parallel to width direction 204 and covering the top surface of housing 210, and with each finger 254 inserted between adjacent ridges 214 of housing 210. Main body 252 of shield 250 engages and is in electrical contact with ground bars 230. Each finger 254 is in alignment with one of the low speed signal contacts 222 located underneath one of the fingers 254, along height direction 206.

As shown in FIG. 14, low speed signal contacts 222 are positioned spaced apart from each other by first contact pitch 222a. Likewise, high speed signal contacts 226 are positioned spaced apart from each other by second contact pitch 226a which is substantially the same as first contact pitch 122a.

Shield 250 includes first segment 250a and second segment 250b along width direction 204. Fingers 254 in first segment 250a are separated from each other by first finger pitch 254a. Fingers 254 in second segment 250b are separated from each by second finger pitch 254b. Second finger pitch 254b is greater than second contact pitch 226a, e.g. as that shown in FIG. 14, second finger pitch 254b is three times as second contact pitch 226a, i.e. there are disposed two high speed contacts 226 between adjacent fingers 254 in the second segment 250b. With first and second finger pitch 254a, 254b configured in the above-illustrated manner, each finger 254 is in alignment with one of the low speed contacts 252, and two or more high speed contacts 226 are disposed between two adjacent fingers 254. As such, high speed contacts 226 are exposed between adjacent fingers 244 of shield 250. Fingers 254 are positioned away from high speed contacts 226 to achieve better signal integrity through reduction in insertion loss and improvement in resonance performance. Shield 250 has the function to hold and engage ground bars 230. Engagement of shield 250 with ground bars 230 improves the signal integrity performance through lower impedance and improved shielding performance.

According to some embodiments, the contacts 220 may also be included in a type of Insert-Molded Leadframe Assembly (IMLA). It will be appreciated that the leadframe assemblies are prepared using conventional techniques. In some embodiments, the housings 110, 210 associated with the leadframe assemblies are insulative housings.

According to some embodiments, at least some portions of the support member 140 and shield 250 are conductive.

According to some embodiments, the fingers can be springy and made of metal.

It should be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

1. An electrical connector, comprising:
a housing having a width direction and a mounting direction orthogonal to the width direction;
a plurality of low speed signal contacts arranged in the housing along the width direction;
a plurality of high speed signal contacts arranged in the housing along the width direction;
a plurality of ground bars, each ground bar being disposed between adjacent two of the low signal contacts;
a member having a body disposed along the width direction, wherein fingers extend laterally from the body;
wherein each of the fingers is in alignment with one of the low speed signal contacts along the mounting direction; and
wherein two or more high speed signal contacts are disposed between adjacent fingers.

2. The electrical connector as recited in claim 1, wherein the body is associated with a support member attached to the housing.

3. The electrical connector as recited in claim 1, wherein the body is associated with a shield attached to the housing.

4. The electrical connector as recited in claim 1, wherein the housing comprises ridges formed on a top surface thereof, and the fingers are inserted between adjacent ridges.

5. The electrical connector as recited in claim 1, wherein the low speed signal contacts are positioned spaced apart by a first contact pitch and the high speed signal contacts are positioned spaced apart by a second contact pitch.

6. The electrical connector as recited in claim 5, wherein the second contact pitch is substantially the same as the first contact pitch.

7. The electrical connector as recited in claim 5, wherein the fingers in a first segment of the body are separated by a first finger pitch and the fingers in a second segment of the body are separated by a second finger pitch.

8. The electrical connector as recited in claim 7, wherein the first finger pitch is the same as the first contact pitch.

9. The electrical connector as recited in claim 8, wherein the second finger pitch is greater than the second contact pitch.

10. The electrical connector as recited in claim 9, wherein each of the fingers is in alignment with one of the low speed signal contacts in the first segment.

11. The electrical connector as recited in claim 10, wherein the two or more high speed contacts are disposed between adjacent fingers in the second segment.

12. The electrical connector as recited in claim 10, wherein the two or more high speed signal contacts are exposed between the adjacent fingers in the second segment.

13. A method of constructing an electrical connector, the method comprising:
attaching a body to a housing of the electrical connector having a width direction and a mounting direction orthogonal to the width direction, wherein a plurality of low speed signal contacts and a plurality of high speed signal contacts are arranged in the housing along the width direction, and the body is disposed along the width direction, and wherein fingers extend laterally from the body;
aligning each of the fingers with one of the low speed signal contacts, wherein two or more high speed signal contacts are disposed between adjacent fingers.

14. The method as recited in claim 13, further comprising:
inserting the fingers between ridges formed on a top surface of the housing.

15. The method as recited in claim 13, wherein attaching the body further comprises:
attaching a support member having the body to the housing.

16. The method as recited in claim 13, wherein attaching the body further comprises:
attaching a shield having the body to the housing.

17. The method as recited in claim 13, further comprising:
exposing the two or more high speed signal contacts between the adjacent fingers.

18. A method of operating an electrical connector, comprising a conductive body attached to a housing of the electrical connector having a width direction and a mounting direction orthogonal to the width direction, and the conductive body is disposed along the width direction, and wherein fingers extend laterally from the conductive body such that the fingers are aligned with first type signal contacts and two or more second type signal contacts are disposed between adjacent fingers, the method comprising:
coupling low speed signals through the first type signal contacts; and
coupling high speed signals through the second type signal contacts.
